(19) United States
(12) Patent Application Publication
(10) Pub. No.: US 2026/0256657 A1
(43) Pub. Date: Sep. 3, 2026

(54) TPE PACIFIER

(71) Applicants: Niels Peter Estrup, HINNERUP (DK); PAPA'S GOT A BRAND NEW TAG, HINNERUP (DK)

(72) Inventor: Niels Peter ESTRUP, HINNERUP (DK)

(21) Appl. No.: 18/875,180

(22) PCT Filed: Jun. 1, 2023
(86) PCT No.: PCT/DK2023/050136

§ 371 Date: Dec. 16, 2024

(30) Foreign Application Priority Data
Jun. 15, 2022 (DK) PA202200576
Sep. 29, 2022 (DK) PA202200885

(51) Int. Cl. A61J 17/00

(52) U.S. Cl. CPC A61J 17/001; A61J 17/101; A61J 17/103

(57) ABSTRACT

This TPS Pacifier (thermoplastic elastomers based on Styrenic-block-copolymers) is the alternative to nature rubber and silicone pacifiers. The flexible and/or rigid material TPS offers better resistance towards biting but most importantly it is 100% recyclable. When a 2 component injected molded pacifier it will have an airtight nibble, this feature makes the pacifier far more hygienic since there are no gabs, no liquid can enter the nipple, when boiling the nipple, or the pacifier. The pacifier in two or more molds with different flexibilities and colors with and/or rigid material TPE. The pacifier can be made in a one-piece tool or in a way where the nipple is molded on its own and then later assembled to the shield. This way the pacifier can be made (injection mold) to have a flexible and/or a rigid shield and a TPS (Thermo plastic elastomers based on Styrenic-block-copolymers) nipple.

### FIELD OF THE INVENTION

The present invention relates to a pacifier, comprising a nipple and a shield made in a recyclable material, but still strong and safe.

Pacifiers are in generations made of rigid plastics shields and with nipples made of silicone or latex/rubber. Some pacifiers are even made of two kind of materials molded together like an over-molding process, then it appears as a one-piece pacifier. The expired patent US-20030100922 A1 from 2001 is an example of a pacifier made of flexible Elastomer on the outside of the pacifier and with a rigid center/inside of the pacifier, this will be made in a two process injection mold, first the inner part will be molded, then the outside/surface will be molded on top of the first molded material.

Another patent WO 2021/010381 A1, describes a hospital pacifier made of a silicone rubber, isoprene rubber. Silicone and rubber does not appear in the TPE pacifier since the material in the TPE pacifier it is based on Styrenic-block-copolymers and can be recycled, which silicone and rubber cannot.

A patent US 2009/0312796 are claiming that they have a pacifier made of thermoplastic elastomer, but they have a cross-linked security thread into the nipple and shield and the “thread” is made in a different material, so the pacifier US. However, pacifiers made of thermoplastic elastomer (TPE) is known from the following prior art documents—but none of these pacifiers are made entirely of the same material, which is Thermoplastic elastomer based on Styrenic-block-copolymers.

The US 2009/0312796 is not entirely made of TPE, since they have added a thread inside the nipples sides and into the shield too, this patented thread is made of a firmer material than the relatively soft nipple, meaning that they have 2 kind of material in their solution of a pacifier. The US 2009/0312796 invention/patent also mentions a firm and a soft material in their claim 1.

Another patent WO 2009/053699 A1 also mentions a soother made of a relatively flexible material, but again this invention is made of two types of material co-molded together, one material more rigid than the flexible material.

The TPS pacifier is made in one process and with one material or in several parts flexible and/or in rigid parts being, injected molded. The difference between this TPS pacifier and already known pacifiers is the production without over mold, co-mold where there's is a rigid center underneath the TPS, this invention TPS pacifier is made of solid TPS.

The TPS pacifier can be made in a one-piece tool or in a way where the nipple is molded on its own in one material and then assembled to the shield afterwards.

The TPS pacifier makes it more simple to produce since this pacifier can be molded in one go, but most importantly, the TPS pacifier can be recycled 100%. Only made of TPE and if the shield is made of a rigid material, this can be recycled too.

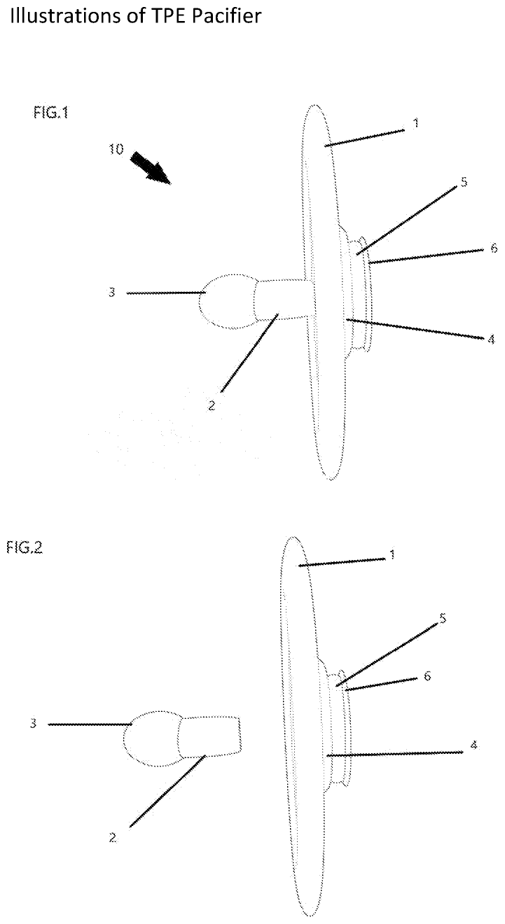

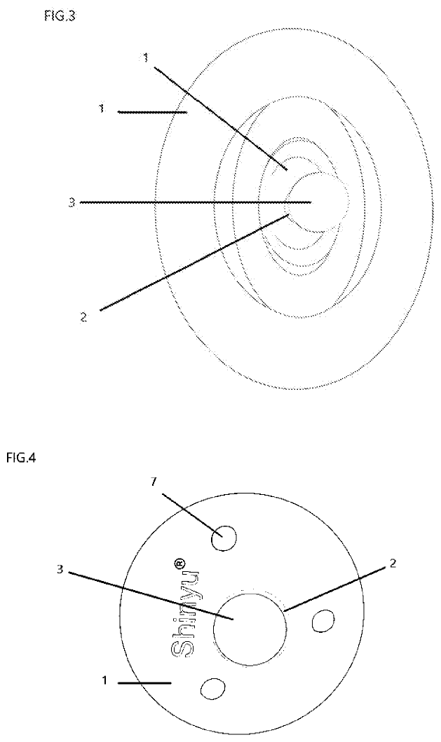

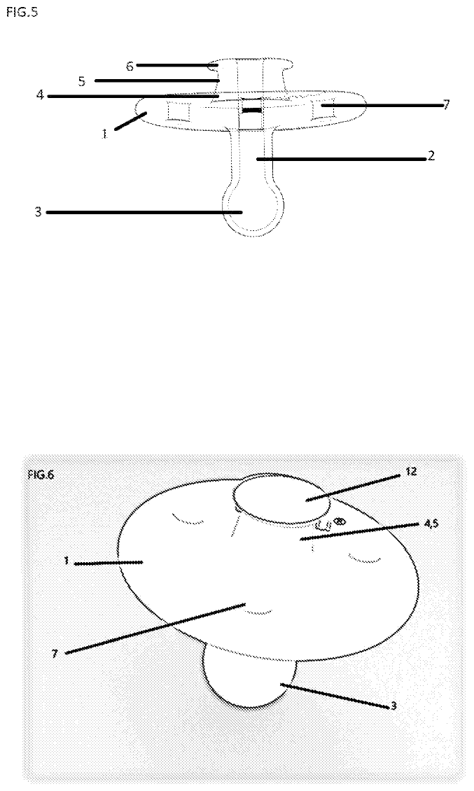

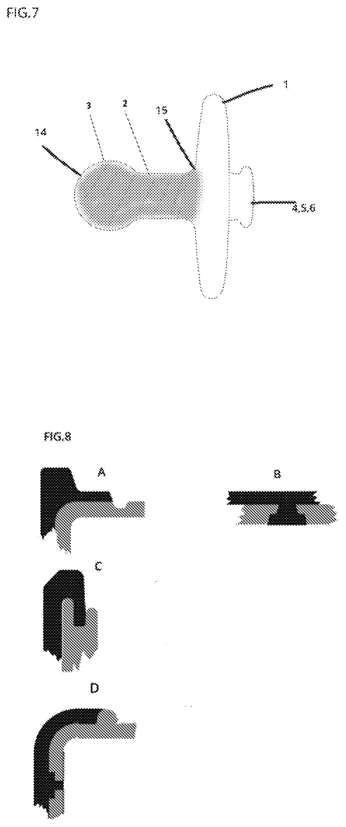

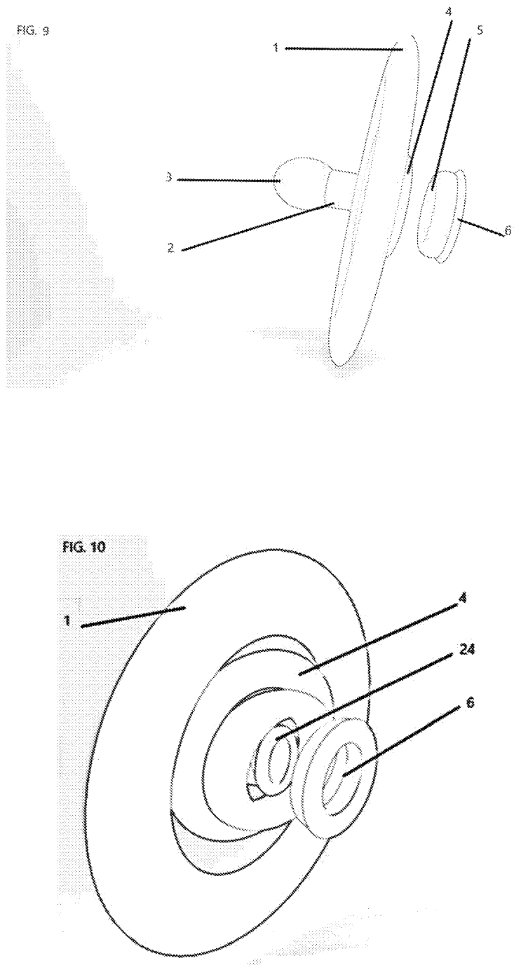

A known pacifier/soother patent DE 4229224 A1 (MAPA GMBH GUMMI PLASTIKWERKE) 1994.03.10 describes an injection molded teat with-a mouthpiece—a shield—a handle—where the handle is located at the back of the shield and the mouthpiece is cast on the face of the shield (see FIG. 1-2), and where the shield is cast in a harder material than the mouthpiece and where the shield has an open rear end, close to our invention but a big difference is that the patent DE 4229224 A1 patent does not vary in material thickness so that the thickest part is the handle, the thinnest part is the mouthpiece and in between is the thickness of the shield.

The TPE injected molded pacifier is also different in the choice of material, where the TPE injected molded pacifier is made of the specific The thermoplastic elastomer on styrenic-block-copolymers (TPE). Also The shield on the TPE injected molded pacifier can be a 2 component injected molded pacifier with a closed back, where the mouthpiece is airtight and closed towards the handle end and also the invention of this new pacifier specific is produced by 2-component injection molding and this is not the case in the patent DE 4229224 A1.

1. A TPE (Thermoplastic elastomers) pacifier (10) comprising a nipple (2,3), a shield (1) and a grip (4,5,6), where the pacifier (10) is made in a one-piece or in several parts flexible and/or in rigid parts being, injected molded, with a grip area (4,5,6) on the back of the shield (1), where the pacifier (10) will variate in material thickness, the nipple part (2,3) as the thinnest part and the shield (1) thicker than the nipple and the grip (4,5,6) the thickest part of the pacifier (10), and a hole (8) going inside the pacifier on the back side of the shield (1) allowing air into the inside of the nipple (14, 2,3) characterized in that the pacifier (10) is made entirely of the same material, which material is TPS (Thermoplastic elastomers based on Styrenic-block-copolymers), wherein the pacifier is a 2-component injection molded pacifier made of a thermoplastic elastomer of styrenic block copolymer, where the nipple (2, 3) is molded onto the shield (1) wherein the shield (1) is in two-piece or in several parts made of flexible or rigid material. Wherein the nipple (2, 3) is placed on the front side (15) of the shield (1) and where the shield (1) has a closed backside (4, 5, 6) and an airtight nipple (14).

2. The TPE pacifier according claim 1 where the shield (1) has air holes (7).

3. The TPE pacifier (10) can also be injected molded in more than two pieces up to 3 or 6 parts could be made into one mold, so the pacifier could have more than 6 different materials molded together and made into one pacifier in the same injection tool and at the same time, but made with different materials if needed.

4. The TPE pacifier (10) according to claim 1, will be made of wholly renewable TPS (Thermoplastic elastomers based on Styrenic-block-copolymers).

5. The TPE pacifier according to claim 1, can be made of anti-bacterial TPS (Thermoplastic elastomers based on Styrenic-block-copolymers).

6. The TPE pacifier according to claim 1, made of color changing thermoplastic Polymer elastomer material in the nipple part, this material (2,3) can change color when the temperature in the mouth is higher than 37 degrees or lower if preferred, this will indicate whether the baby have a fever, high temperature in the mouth.

7. The TPE pacifier according to claim 1,2 can be made of an odeur giving Thermoplastic elastomers based on Styrenic-block-copolymers in the nipple (2,3) or and in the shield (1) in and flexible or rigid material. The odeur can be lemon, strawberry smelling or milk smelling odor, which could be comforting the baby when using and smelling the pacifier.

8. The TPE pacifier according to claim 1, where the pacifier is injected molded in a 2 component way the shield (1) can be made of flexible or rigid materiel, and behind the grip (4,5,6) of the pacifier there will be enough room to put a loop of string or other flexible material around the grip area (4,5,6) to ensure a pacifier string/strap, so the pacifier don't fall onto the floor when the child loses the pacifier out of the hands.
